(19) United States
(12) Patent Application Publication
(10) Pub. No.: US 2024/0300134 A1
(43) Pub. Date: Sep. 12, 2024

(54) CUTTING DEVICE AND CUTTING METHOD

(71) Applicant: SEIKO EPSON CORPORATION, Tokyo (JP)

(72) Inventor: Makoto YOSHIDA, Matsumoto (JP)

(21) Appl. No.: 18/594,069

(22) Filed: Mar. 4, 2024

(30) Foreign Application Priority Data
Mar. 6, 2023 (JP) 2023-033522

(51) Int. Cl. B26D 7/01; B26D 1/06

(52) U.S. Cl. CPC B26D 7/015; B26D 1/065

(57) ABSTRACT

A cutting device configured to be disposed on a transportation path along which a web including at least accumulated fibers is transported includes: a cutter configured to cut the web; and a movable needle configured to stick into the web to hold the web when the web is cut.

The present application is based on, and claims priority from JP Application Serial Number 2023-033522, filed Mar. 6, 2023, the disclosure of which is hereby incorporated by reference herein in its entirety.

### BACKGROUND

### 1. Technical Field

The present disclosure relates to a cutting device and a cutting method.

### 2. Related Art

A cutting device configured to be disposed on a transportation path along which a fiber material is transported and configured to cut the fiber material is known (see, for example, JP-A-2019-085264). JP-A-2019-085264 discloses a sheet recycling technology in a dry method for regenerating sheets from a web including accumulated fibers and a technology in which the web is compressed with a pressing roller into a sheet shape and is cut by a cutting device.

However, since the web is soft and uncompressed, the web is easily shifted when cut in the related art, which degrades cutting accuracy.

### SUMMARY

An aspect of the present disclosure is a cutting device configured to be disposed on a transportation path along which a web including at least accumulated fibers is transported and configured to cut the web, the cutting device including: a cutter configured to cut the web; and a movable needle configured to stick into the web to hold the web when the web is cut.

An aspect of the present disclosure is a cutting method using a cutting device disposed on a transportation path along which a web including at least accumulated fibers is transported, the cutting device including a cutter configured to cut the web and a movable needle configured to stick into the web, the cutting method including sticking the needle into the web to hold the web when the web is cut.

### BRIEF DESCRIPTION OF THE DRAWINGS

FIG. 1 is an outline configuration diagram of a sheet manufacturing apparatus including a cutting device according to the present embodiment.

FIG. 2 is a diagram illustrating the cutting device together with a transportation path of a second web.

FIG. 3 is a diagram illustrating the operation of a cutter unit in time series.

FIG. 4 is a cross-sectional view of a web holding mechanism and its peripheral configuration.

FIG. 5 is a diagram of the cross-sectional structure illustrated in FIG. 4 as viewed obliquely.

FIG. 6 is a schematic diagram of the cross-sectional structure illustrated in FIG. 4.

FIG. 7 is a diagram illustrating the operation of the web holding mechanism in time series.

FIG. 8 is a diagram illustrating operation continued from FIG. 7.

FIG. 9 is a diagram for explaining a modification example.

### DESCRIPTION OF EMBODIMENTS

Hereinafter, an embodiment of the present disclosure will be described with reference to the drawings.

### 1. Configuration of Sheet Manufacturing Apparatus

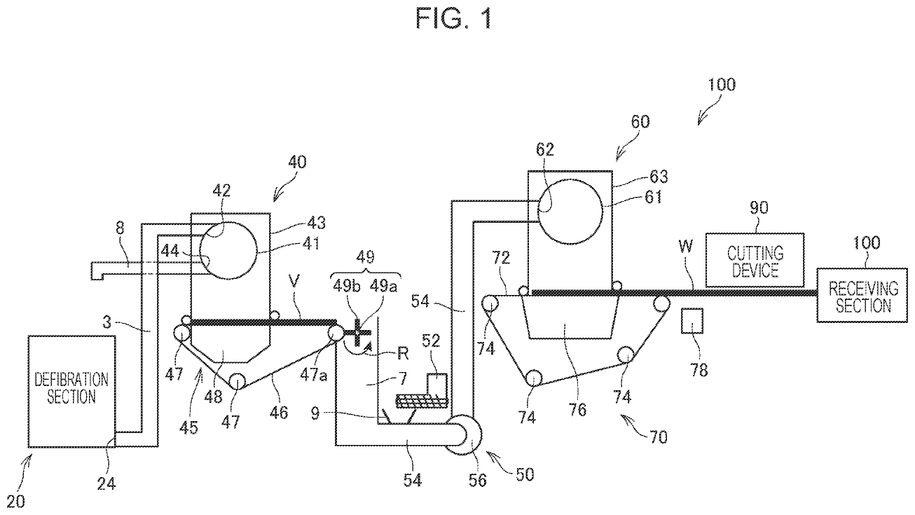

FIG. 1 is an outline configuration diagram of a sheet manufacturing apparatus 10 including a cutting device according to the present embodiment. The sheet manufacturing apparatus 10 is configured to perform a sheet recycling process in a dry process by defibrating a raw material containing fibers, accumulating the defibrated material to form a web, and regenerating or manufacturing sheets from the web. Examples of raw materials containing fibers include paper, pulp, pulp sheets, cloth including nonwoven fabrics, and woven fabrics. Note that the web includes at least a fiber material including accumulated fibers. The web may include, in addition to the fiber material, holding layers in the form of thin films located on both of the upper and lower sides of the fiber material. Note that the fiber material may contain functional powders having properties such as a hygroscopic property. As illustrated in FIG. 1, the sheet manufacturing apparatus 10 includes a defibration section 20, a screening section 40, a first web-formation section 45, a rotator 49, a mixing section 50, an accumulation section 60, a second web-formation section 70, and a cutting device 90.

The sheet manufacturing apparatus 10 has a receiving section 100 located downstream of the cutting device 90 and configured to receive pieces of the web cut by the cutting device 90. The receiving section 100 is, for example, a sheet forming device that forms sheets from cut pieces of the web, more specifically, a device that performs pressing, heating, and the like on the web to form sheets. Note that the receiving section 100 is not limited to a sheet forming device. For example, when a sheet forming device is disposed away from the cutting device 90, the receiving section 100 may be a storage device that temporarily stores the web.

The defibration section 20 defibrates cut raw material. The raw material, for example, is cut into small pieces in a gas such as air and is then supplied to the defibration section 20. The raw material may be used material such as waste paper, or may be fresh material. Waste paper denotes so-called used paper. The term “defibrating” denotes unraveling raw material in which a plurality of fibers are bound, into individual fibers. The raw material refers to coarsely crushed pieces or sometimes refers to material for defibration. The defibration section 20 also has a function of separating substances such as resin particles, ink, toner, and anti-bleed agents attached to the raw material from the fibers.

The material obtained by defibration in the defibration section 20 corresponds to defibrated material. Defibrated material contains not only unraveled fibers but sometimes also contains resin particles separated from fibers when the fibers are unraveled, coloring agents such as ink and toner, and additives such as anti-bleed agents and paper strengthening agents. The defibrated material is in the form of strings. Defibrated material may be in a state of not being tangled with other unraveled fibers, in other words, in a separate state, or it may be in a clumped state in which defibrated material is tangled with other unraveled fibers, in other words, in a state in which clumps are formed.

The defibration section 20 performs defibration as a dry process. Performing a process such as defibration, accumulation, and the like not in a liquid but in a gas such as air is referred to as a dry process. The defibration section 20 is configured to perform defibration by using, for example, an impeller mill but not is limited to this configuration. The defibration section 20 has a function of generating an air flow for sucking the raw material cut into small pieces and discharging the defibrated material. With this function, the defibration section 20 transports the defibrated material to an outlet 24 by using the air flow generated by the defibration section 20. The defibrated material is transported to the screening section 40 through a pipe 3. The air flow for transporting the defibrated material from the defibration section 20 to the screening section 40 is not limited to the air flow generated by the defibration section 20. An air-flow generation device such as a blower may be provided, and the generated air flow may be used.

The screening section 40 receives the defibrated material through an inlet 42 and screens the defibrated material according to fiber length. Although the configuration of the screening section 40 is not particularly limited, the screening section 40 of the present embodiment includes a drum 41 and a housing 43 that houses the drum 41. The drum 41 may employ, for example, a cylindrical sieve rotationally driven by a motor. The drum 41 includes a net and is capable of separating fibers or particles smaller than the size of the mesh of the net, in other words, a first screened material that passes through the net, from fibers, undefibrated scraps, and clumps larger than the size of the mesh of the net, in other words, a second screened material that does not pass through the net. The first screened material is transported to the accumulation section 60 through a pipe 7. The second screened material is returned to the defibration section 20 through an outlet 44 and a pipe 8.

The first web-formation section 45 transports the first screened material having passed through the screening section 40 to the pipe 7. The first web-formation section 45 in the illustrated example includes a mesh belt 46, tension rollers 47, and a suction mechanism 48, but is not limited to this configuration.

The suction mechanism 48 is configured to draw the first screened material having passed through the openings of the screening section 40 and dispersed in air, onto the mesh belt 46. The first screened material is accumulated on the moving mesh belt 46 and forms a web V. The basic configurations of the mesh belt 46, the tension rollers 47, and the suction mechanism 48 are the same as or similar to those of a mesh belt 72, tension rollers 74, and a suction mechanism 76 in the second web-formation section 70 described later.

The web V, which is formed of the material having passed through the screening section 40 and the first web-formation section 45, contains a large amount of air and is soft and puffy. The web V accumulated on the mesh belt 46 is input into the pipe 7 and is transported to the accumulation section 60.

The rotator 49 cuts the web V by its rotation. Although the configuration of the rotator 49 is not particularly limited, the rotator 49 in the present embodiment includes a base 49a and a plurality of protrusions 49b protruding radially from the base 49a. Each protrusion 49b is in the form of, for example, a plate-shaped blade. By the base 49a rotating in the direction R in FIG. 1, the protrusions 49b rotates on the base 49a and can cut the web V.

The rotator 49 is located near a tension roller 47a located downstream on the path of the web V and thus located downstream of the first web-formation section 45. The rotator 49 is located at a position where the protrusions 49b can come into contact with the web V and do not come into contact with the mesh belt 46 on which the web V is accumulated.

The mixing section 50 mixes the first screened material having passed through the screening section 40 and additives. The mixing section 50 includes an additive supply portion 52 that supplies additives, a pipe 54 that transports the first screened material and the additives, and a blower 56. The additives are supplied from the additive supply portion 52 via a hopper 9 into the pipe 54. The pipe 54 is continuous with the pipe 7.

In the mixing section 50, the blower 56 generates an air flow, which transports the first screened material and the additives while mixing them in the pipe 54. Note that the configuration for mixing the first screened material and the additives is not particularly limited and is, for example, one that performs stirring with high-speed rotary blades or one that utilizes the rotation of a container, such as a V blender.

The additive supply portion 52 has a configuration in which, for example, the additives are supplied by using a screw feeder or a disk feeder, but is not limited to this configuration. An additive supplied from the additive supply portion 52 is, for example, a binder for binding a plurality of fibers. Depending on the type of sheet to be manufactured, the additives supplied from the additive supply portion 52 may include a coloring agent for coloring fibers, an aggregation inhibitor for inhibiting aggregation of fibers and additives, and a flame retardant for reducing flammability of fibers. The mixture having passed through the mixing section 50 is transported to the accumulation section 60 through the pipe 54.

The accumulation section 60 receives the mixture having passed through the mixing section 50 through an inlet 62, unravels tangled defibrated material, and causes the mixture to fall in air while dispersing the mixture. The accumulation section 60 causes the defibrated material to be accumulated in a dry process and forms a second web W composed of a soft web. As described above, the second web W formed by the accumulation section 60 is an uncompressed fiber material.

In addition, when a resin supplied from the additive supply portion 52 as an additive is in the form of fibers, the accumulation section 60 unravels tangled resin fibers. This operation enables the accumulation section 60 to accumulate the mixture uniformly on the second web-formation section 70. Although the configuration of the accumulation section 60 is not particularly limited, the accumulation section 60 of the present embodiment includes a drum 61 and a housing 63 that houses the drum 61. The drum 61 employs, for example, a cylindrical sieve rotationally driven by a motor. The drum 61 has a net, which enables fibers or particles smaller than the size of the mesh of the net, contained in the mixture having passed through the mixing section 50 to fall.

Note that the sieve of the drum 61 is not limited to having a function of screening a specific target substance. In other words, the sieve used as the drum 61 denotes a member with a net, and hence, the drum 61 may allow all of the mixture introduced into the drum 61 to fall.

The second web-formation section 70 causes the passed-through material having passed through the accumulation section 60 to accumulate and form a second web W and also serves as at least part of the transportation path for transporting the second web W. Although the configuration of the second web-formation section 70 is not particularly limited, the second web-formation section 70 in the present embodiment includes the mesh belt 72, the tension rollers 74, and the suction mechanism 76.

The passed-through material having passed through the openings of the accumulation section 60 accumulates on the mesh belt 72. The mesh belt 72 is stretched on the tension rollers 74 and configured in a manner such that it is difficult for the passed-through material to pass through and easy for air to pass through. The mesh belt 72 is moved by the rotation of the tension rollers 74. While the mesh belt 72 is continuously moving, the passed-through material having passed through the accumulation section 60 continuously falls onto the mesh belt 72, forming a soft uncompressed second web W.

The suction mechanism 76 is located under the mesh belt 72 and configured to suck the passed-through material dispersed in air by the accumulation section 60, onto the mesh belt 72 and promotes formation of the second web W. This configuration enables an increase in the speed of discharge from the accumulation section 60 and forms a downflow in the falling path of the mixture to prevent the defibrated material and the additives from tangling while falling.

The second web W, which is formed of the material having passed through the accumulation section 60 and the second web-formation section 70 as described above, contains a large amount of air and is soft and uncompressed. The cutting device 90 is located on the transportation path of the second web W and configured to cut the web W being transported. Note that the sheet manufacturing apparatus 10 may include a moisture addition section for adding moisture to the defibrated material in some cases. The moisture addition section is capable of adjusting the water content of the second web W within a specified range to bond a plurality of fibers contained in the defibrated material by hydrogen bonding.

### 2. Configuration of Cutting Device

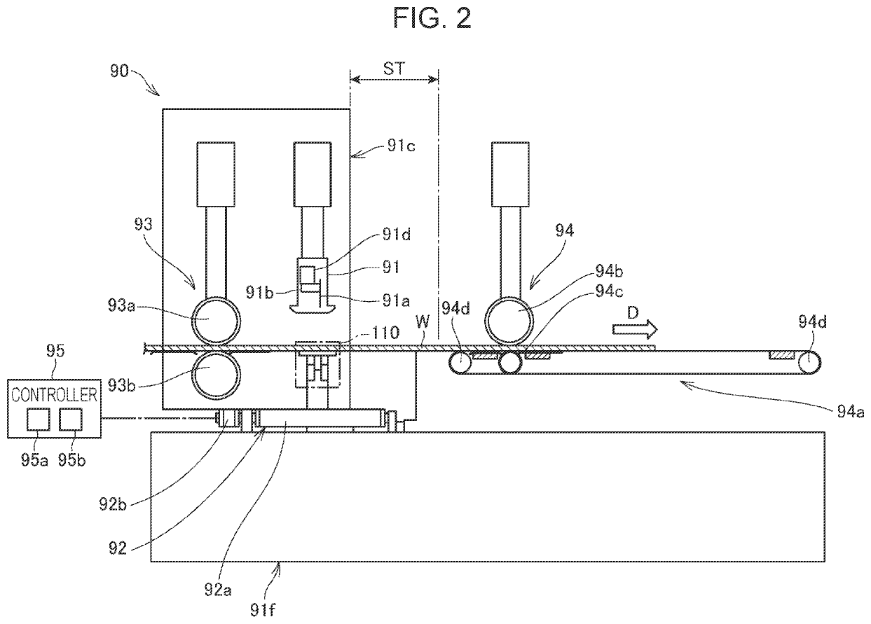

FIG. 2 is a diagram illustrating the cutting device 90 together with the transportation path of the second web W. The symbol D in FIG. 2 indicates the transportation direction of the second web W. The cutting device 90 includes a cutter unit 91, a ball screw mechanism 92, an upstream transportation mechanism 93, a downstream transportation mechanism 94, a web holding mechanism 110, and a controller 95 that controls the operation of the cutting device 90. The cutter unit 91 includes a cutter 91a for cutting the second web and a cutter movement mechanism 91b that moves the cutter 91a, and these are supported above the second web W by a movable frame 91c.

The cutter 91a is a blade used to cut the second web W in the width direction of the second web W and is a rotary blade having a diameter shorter than the entire width of the second web W in the present embodiment. The cutter 91a is rotationally driven by a motor 91d for the cutter, supported by the movable frame 91c. The cutter movement mechanism 91b is configured to move the cutter 91a in the up-down direction and the right-left direction. Note that the up-down direction and the right-left direction are directions based on the cutting device 90. The up-down direction corresponds to the direction in which the cutter 91a is moved toward and away from the second web W, and the right-left direction corresponds to the width direction of the second web W, in other words, the cutting direction of the second web W.

Although the configuration of the cutter movement mechanism 91b is not particularly limited, for example, the cutter movement mechanism 91b includes a combination of publicly-known mechanisms such as a linear reciprocating mechanism including a rack & pinion and a mechanism including a linear actuator. The movable frame 91c includes a combination of a pillar member extending in the up-down direction and a cross beam extending in the horizontal direction and supports the upstream transportation mechanism 93 in addition to the cutter unit 91. This movable frame 91c is supported by a base frame 91f functioning as the base of the cutting device 90 and functions as a movable table that is moved by the ball screw mechanism 92 in the transportation direction of the second web W relative to the base frame 91f.

The ball screw mechanism 92 is located below the transportation path of the second web W and supported by the base frame 91f. The ball screw mechanism 92 includes a ball screw 92a extending in the transportation direction of the second web W, and the ball screw 92a is rotationally driven by a motor 92b for the ball screw, located on one end side of the ball screw 92a. Note that the movable frame 91c is supported movably in the transportation direction of the second web W and the opposite direction by, for example, a linear motion guide and is coupled to a nut unit coupled to the ball screw 92a in a manner of thread engagement. When the nut unit, along with the rotation of the ball screw 92a, moves in the axis direction of the ball screw 92a, in other words, the transportation direction of the second web W or the opposite direction, the movable frame 91c moves in the transportation direction of the second web W or the opposite direction. The position, the movement direction, and the moving speed of the movable frame 91c are controlled by controlling the rotation angle, the rotation direction, and the rotation speed of the ball screw 92a. The symbol ST in FIG. 2 indicates the movement range, in other words, the movement stroke, of the movable frame 91c.

The upstream transportation mechanism 93 is located upstream of the cutter 91a and includes upper and lower transportation rollers 93a and 93b facing each other with the second web W interposed therebetween. By at least one of the upper and lower transportation rollers 93a and 93b being rotationally driven, the second web W between the transportation rollers 93a and 93b can be transported in the transportation direction. Each of the transportation rollers 93a and 93b is a rotational roller extending across the entire width of the second web W. The upper transportation roller 93a is movable in the up-down direction so as to move toward and away from the second web W. Since the cutter unit 91, the upstream transportation mechanism 93, driving sources for driving these units, and the like are supported by the movable frame 91c, these units move together in the transportation direction of the second web W and the opposite direction.

The downstream transportation mechanism 94 is located downstream of the cutter 91a and supported by the base frame 91f of the cutting device 90. The downstream transportation mechanism 94 includes a belt mechanism 94a located on the lower side of the second web W, which corresponds to one side when the second web W is pinched, and a transportation roller 94b located on the upper side of the second web W, which corresponds to the other side when the second web W is pinched. The belt mechanism 94a includes a belt 94c extending across the entire width of the second web W and a set of rollers 94d including a driving roller that transports the belt 94c and a driven roller, and when the driving roller rotates for driving, the belt 94c moves in the transportation direction of the second web W.

The transportation roller 94b is a rotational roller extending across the entire width of the second web W and is movable in the up-down direction so as to move toward and away from the second web W. When the transportation roller 94b is at a lower position, the transportation roller 94b and the belt mechanism 94a pinch the second web W. When the belt mechanism 94a and the transportation roller 94b pinching the second web W are driven, the second web W between the belt mechanism 94a and the transportation roller 94b can be transported in the transportation direction.

The web holding mechanism 110 is configured to hold the second web W at a position near the cutter 91a when the cutter 91a cuts the second web W. The web holding mechanism 110 of the present embodiment is located at a position facing the cutter 91a with the second web W interposed therebetween, in other words, under the cutter 91a and under the transportation path of the second web W. The web holding mechanism 110 is supported by the movable frame 91c and moves together with the cutter 91a and the upstream transportation mechanism 93 in the transportation direction of the second web W and the opposite direction. The configuration of the web holding mechanism 110 will be described later.

The controller 95 has a function of controlling each unit of the cutting device 90 and controls at least the motors and the like serving as the driving sources of the cutter unit 91, the ball screw mechanism 92, the upstream transportation mechanism 93, the downstream transportation mechanism 94, and the web holding mechanism 110. The controller 95 includes a processor 95a and memory 95b. The processor 95a is an arithmetic processing device including a central processing unit (CPU), a micro-processing unit (MPU), or the like. The memory 95b is a storage device such as read only memory (ROM), flash memory, and electrically erasable programmable read-only memory (EEPROM) and stores data including a control program.

In the controller 95, the processor 95a executes a control program stored in the memory 95b to load instructions and information on transportation and cutting of the second web W, and controls operation of each unit in the cutting device 90 in synchronization with the transportation of the second web W by using a publicly-known motion control technique.

The processor 95a may be composed of a single processor or a plurality of processors. Alternatively, the processor 95a may be part of an SoC integrally including part or all of the memory 95b and other circuits. The processor 95a may be composed of a combination of a CPU that executes programs and a digital signal processor (DSP) that executes specified arithmetic processing. All of the functions of the processor 95a may be implemented by hardware or may be implemented by a programmable device.

### 3. Operation of Cutter Unit

Next, the operation of the cutter unit 91 will be described. In the present embodiment, the second web W is transported continuously. Specifically, transportation of the second web W toward the cutting device 90 is not interrupted, and the second web W continues to be transported at a predetermined transportation speed. First, as illustrated in FIG. 2, the controller 95 holds the cutter unit 91 at an upper position which is away from the second web W and also at an upstream position of the movement stroke ST by using the ball screw mechanism 92.

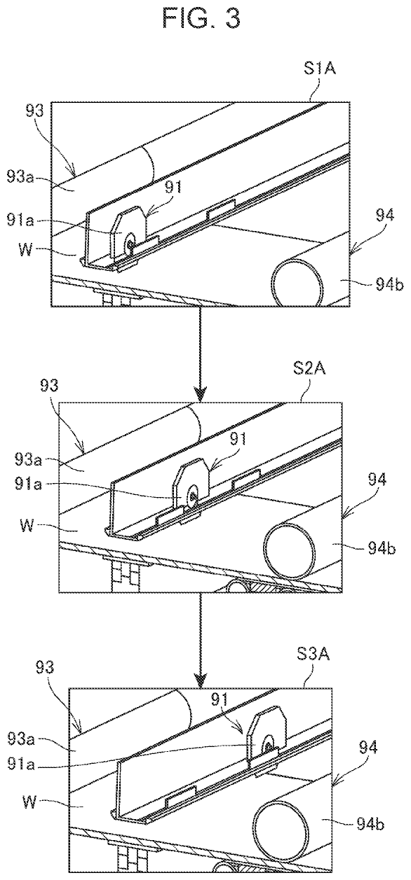

FIG. 3 is a diagram illustrating the operation of the cutter unit 91 in time series. Note that FIG. 3 illustrates an operation from the time point when the second web W reaches a cutting start position where cutting operation of the cutter unit 91 starts. As illustrated in step S1A in FIG. 3, the controller 95 causes the ball screw mechanism 92 to move the cutter unit 91 at the same speed as that of the second web W in the transportation direction, and in synchronization with this movement, moves down the cutter unit 91 to start cutting the second web W. Note that during this operation, the transportation rollers 93a and 93b are stopped. In this operation, as illustrated in steps S1A, S2A, and S3A of FIG. 3, the controller 95 moves the cutter 91a from one side to the other side of the second web W in the width direction while rotationally driving the cutter 91a.

While the cutter 91a is cutting the second web W, the cutter 91a moves at the same speed as the transportation speed. This configuration enables the second web W to be cut in a straight line in the width direction without interrupting transportation of the second web W. In this operation, the controller 95 causes at least both the belt mechanism 94a and the transportation roller 94b of the downstream transportation mechanism 94 to continue transporting the second web W at least until cutting of the second web W is completed and the cutter 91a retreats upward. This operation enables a cut piece of the second web W to be handed over to the receiving section 100 located downstream.

When cutting of the second web W is completed, the controller 95 moves up the cutter unit 91 away from the second web W and returns the cutter unit 91 to the upstream position of the movement stroke ST. The above is a description of the operation, specifically, cutting operation, of the cutter unit 91. This cutting operation is repeatedly executed at specified timings in synchronization with transportation of the second web W, so that the second web W is cut into pieces with a specified length.

### 4. Configuration of Web Holding Mechanism

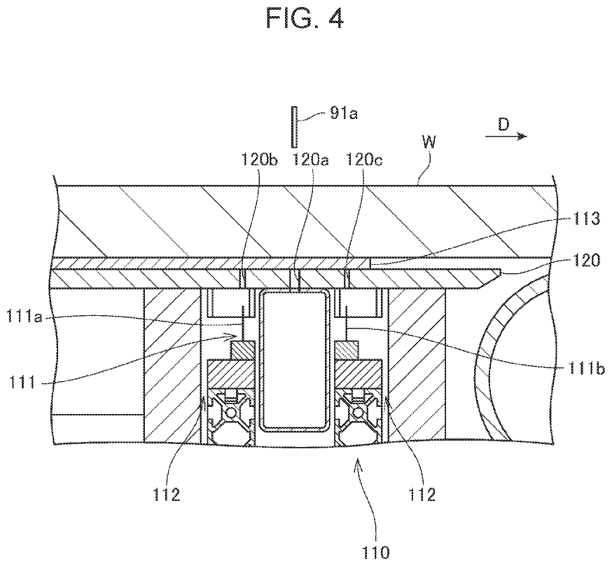

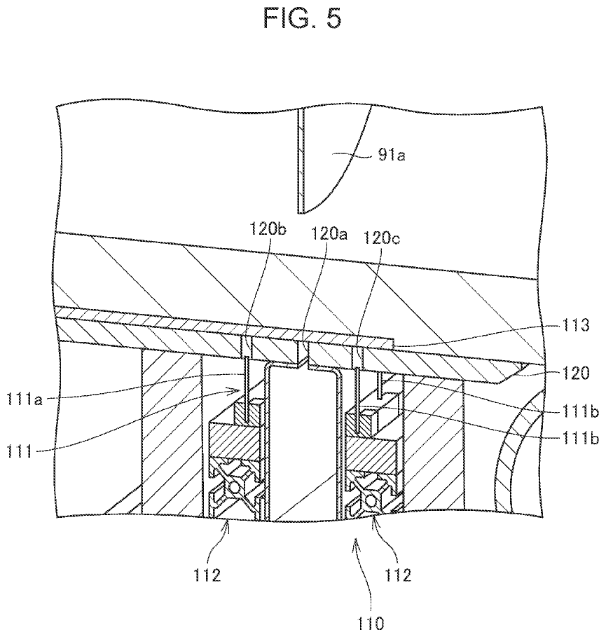

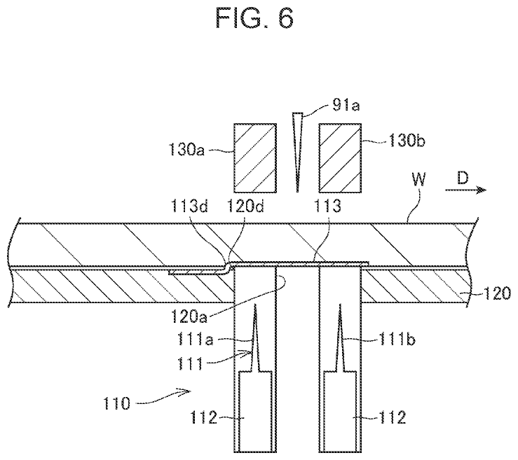

Next, the configuration of the web holding mechanism 110 will be described. FIG. 4 is a cross-sectional view of the web holding mechanism 110 and its peripheral configuration. FIG. 5 is a diagram of the cross-sectional structure illustrated in FIG. 4 as viewed obliquely. FIG. 6 is a schematic diagram of the cross-sectional structure illustrated in FIG. 4. As illustrated in FIGS. 4 and 5, the transportation surface of the second web W is served by a plate-shaped transportation-surface member 120, which has a slit 120a at a position facing the cutter 91a with the second web W interposed therebetween. The cutter 91a at the cutting position enters this slit 120a, which extends across the width of the second web W. This slit 120a functions as a cutter passage slit for avoiding the cutter 91a physically coming into contact with the transportation surface.

As illustrated in FIG. 4, the web holding mechanism 110 includes a plurality of needles 111, a lifting mechanism 112 that moves these needles 111 toward and away from the second web W, and a cover member 113 movable to and away from the position where the cover member 113 covers the slit 120a. The needles 111 include upstream needles 111a configured to stick into the second web W at positions near and upstream of the cutter 91a in the transportation direction and downstream needles 111b configured to stick into the second web W at positions near and downstream of the cutter 91a in the transportation direction.

A plurality of needles 111a and a plurality of needles 111b are spaced in the width direction of the second web W as illustrated in FIG. 5. Note that the transportation-surface member 120 has needle passage holes 120b and 120c each of which a needle 111a or 111b is inserted. The lifting mechanism 112 is configured to move all the needles 111 including the upstream needles 111a and the downstream needles 111b at the same time between a state in which the needles 111 are stuck into the second web W and a state in which these needles 111 are away from the second web W. The lifting mechanism 112 may employ a wide variety of mechanisms configured to move up and down the needles 111. Note that the number, arrangement interval, and shapes of the needles 111 may be designed as appropriate.

Since the needles 111 including the upstream needles 111a and the downstream needles 111b stick into the second web W, it is possible to restrict the positional deviation of the upstream portion and the downstream portion of the second web W with respect to the cut portion. In addition, since the needles 111 are spaced in the width direction of the second web W, it is also possible to restrict the positional deviation in the width direction of the second web W. This configuration enables the second web W including an uncompressed soft fiber material to be cut with the positional deviation of the second web W restricted.

The movable cover member 113 is a thin plate-shaped member located between the second web W and the transportation surface of the second web W, extending across the movement range of the cutter 91a in the width direction of the second web W, and configured to reciprocate in the transportation direction. The cover member 113 is formed by, for example, processing a sheet metal. Since this cover member 113 moves to the position where it covers the slit 120a in which the cutter 91a passes, it is possible to prevent the second web W from being caught at the slit 120a. In addition, as illustrated in FIGS. 4 and 5, when the cover member 113 is at the position where it covers the slit 120a, the cover member 113 also covers the needle passage holes 120b and 120c. Thus, it is also possible to prevent the second web W from being caught at the needle passage holes 120b and 120c.

FIG. 6 illustrates an example in which the transportation surface has a step 120d upstream of the slit 120a, and the cover member 113 has a step-caught portion 113d that is caught by the step 120d. With this configuration, when the cover member 113 is slidden in the transportation direction, the step-caught portion 113d is caught by the step 120d, so that the cover member 113 can be easily stopped at an appropriate position, specifically, at a position where the cover member 113 covers the slit 120a and the needle passage holes 120b and 120c. This configuration makes it possible to position the cover member 113, when it is stopped, easily at a position where it covers the slit 120a and the needle passage holes 120b and 120c. Note that instead of having the step 120d and the step-caught portion 113d, the position of the cover member 113 may be controlled so that the cover member 113 can stop at a position where it covers the slit 120a and the needle passage holes 120b and 120c.

FIG. 6 also illustrates examples of web pressing portions 130a and 130b located at the front and rear of the cutter 91a, in other words, at upstream and downstream positions relative to the cutter 91a in the transportation direction and configured to move toward and away from the second web W. These web pressing portions 130a and 130b are supported by the movable frame 91c or the cutter unit 91 and move together with the cutter 91a in the transportation direction of the second web W and the opposite direction. These web pressing portions 130a and 130b move toward the second web W under control of the controller 95 when the cutter 91a cuts the second web W, and press the second web W from above.

### 5. Operation of Web Holding Mechanism

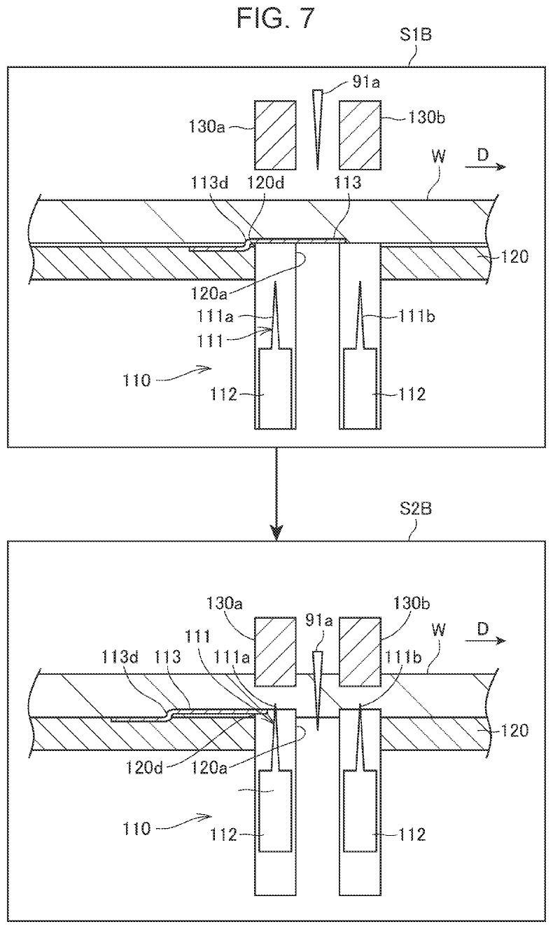

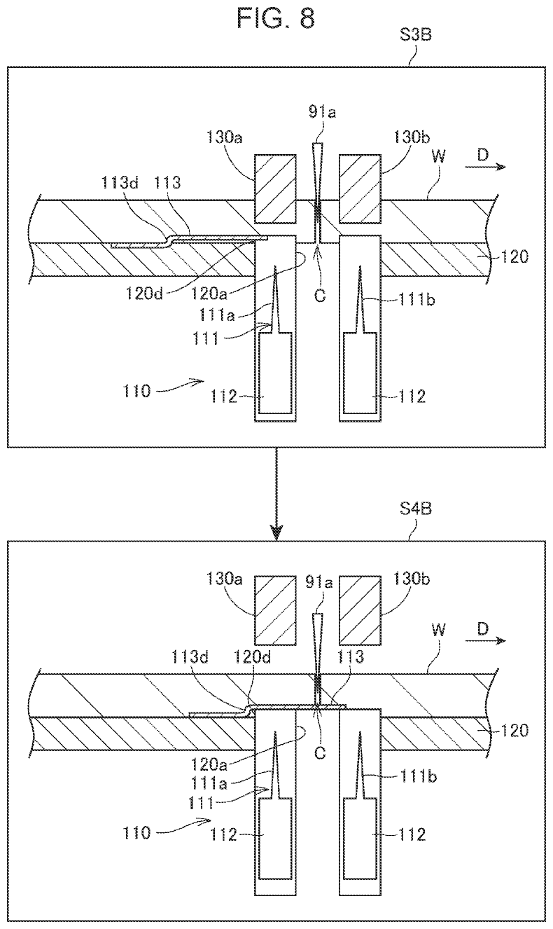

Next, operation of the web holding mechanism 110 will be described. FIGS. 7 and 8 are diagrams illustrating the operation of the web holding mechanism 110 in time series. Step S1B in FIG. 7 illustrates a state before the cutter 91a starts cutting the second web W. In step S1B, the controller 95 holds the needles 111 at a lower position away from the second web W and also holds the cover member 113 at a position where it covers the slit 120a and the needle passage holes 120b and 120c.

When the cutter unit 91 moves down and starts cutting the second web W in synchronization with transportation of the second web W, the controller 95, as illustrated in step S2B in FIG. 7, moves the cover member 113 upstream in the transportation direction and causes the lifting mechanism 112 to move the needles 111 to a position where they stick into the second web W. This operation enables the cutter 91a to start cutting the second web W with the positional deviation of the second web W restricted by the needles 111. In this operation, the controller 95 moves the web pressing portions 130a and 130b toward the second web W to press the second web W also from the side opposite to the needles 111. This operation prevents the second web W from being raised by the needles 111 and enables the needles 111 to stick into the second web W sufficiently. Thus, it is possible to effectively restrict the positional deviation of the second web W by using the needles 111 and the web pressing portions 130a and 130b.

When the cutter 91a completes cutting the second web W, the controller 95, as illustrated in step S3B in FIG. 8, causes the lifting mechanism 112 to move the needles 111 to a position away from the second web W. In this operation, when part of the cut portion of the second web W, indicated by symbol C in FIG. 8, protrudes into the slit 120a due to the cutter 91a or an effect of gravity, and the second web W is transported in the transportation direction in this state, there is a possibility that the cut portion C of the second web W can be caught at the slit 120a or the needle passage holes 120b and 120c.

In the present embodiment, when the cutter 91a finishes cutting, the controller 95, as illustrated in step S4B in FIG. 8, moves the cover member 113 downstream in the transportation direction to the position where the cover member 113 covers the slit 120a and the needle passage holes 120b and 120c. This operation prevents the second web W from being caught at the slit 120a and the needle passage holes 120b and 120c. The above is a description of the web holding operation by the web holding mechanism 110. This web holding operation is repeatedly executed at specified timings in synchronization with transportation and cutting operation of the second web W, so that the second web W can be cut with the positional deviation of the second web W restricted, and that the second web W can be moved smoothly.

As described above, the cutting device 90 according to the present embodiment includes the cutter 91a that cuts the second web W including accumulated fibers and the movable needles 111 that stick into the second web W to hold the second web W when the second web W is cut. This configuration enables the second web W which is soft and uncompressed to be cut with the positional deviation of the second web W restricted, which improves cutting accuracy.

The needles 111 are located under the second web W and move up when the second web W is cut. Since the needles 111 are not disposed over the second web W in this configuration, it is easy to make a sufficient space over the second web W, and thus, for example, it is easy to allocate a sufficient space for the cutter 91a over the second web W.

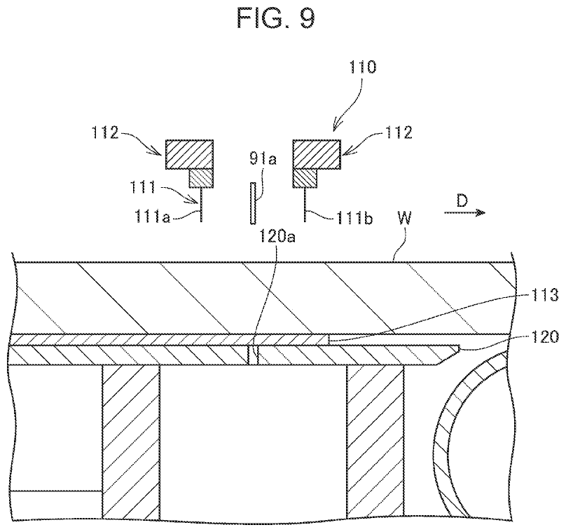

The positions of the needles 111 may be changed as appropriate. For example, as illustrated in FIG. 9, needles 111 may be located over the second web W and configured to move down when the second web W is cut. In this configuration, since the lower side of the second web W is supported by the transportation surface, and the needles 111 stick into the second web W from above, it is easy to sufficiently stick the needles 111 into the second web W. This makes the second web W having a positional deviation less likely. Since the needles 111 are not disposed under the second web W, it is easy to make a sufficient space under the second web W, and thus, for example, it is easy to allocate a sufficient space for the ball screw mechanism 92. This configuration also makes the needle passage holes 120b and 120c unnecessary in the transportation surface.

In addition, the slit 120a is located at a position facing the cutter 91a with the second web W interposed therebetween, and the needles 111 are located at both upstream and downstream positions relative to this slit 120a in the transportation direction of the second web W. This configuration makes it easy to restrict the positional deviation of the second web W by using the needles while the slit 120a prevents the cutter 91a from coming into contact with the transportation surface. In addition, since the positional deviation of the second web W is restricted at an upstream position and a downstream position with respect to the cut portion of the second web W, this is advantageous to improving cutting accuracy. Note that as a possible configuration, needles 111 may be located at only one of an upstream position and a downstream position relative to the slit 120a in the transportation direction of the second web W. In this case, since the needles 111 are spaced in the width direction of the second web W, it is possible to effectively restrict the positional deviation of the second web W in the width direction, and this is advantageous to improving cutting accuracy.

In addition, the embodiment includes the movable cover member 113 that covers the slit 120a when cutting is not performed. With this configuration, the cover member 113 prevents the second web W from being caught at the slit 120a and the like, smoothing the transportation of the second web W.

The embodiment also includes the ball screw mechanism 92 that moves the cutter 91a and the needles 111 in the transportation direction of the second web W during transportation of the second web W. This configuration improves cutting accuracy when the cutter 91a cuts the second web W without interrupting transportation of the second web W. This is advantageous to improving performance such as high-speed operation and cutting performance of the sheet manufacturing apparatus 10.

The present embodiment is to show an aspect, and hence, the embodiment can be changed and applied in any way within a range not departing from the spirit of the present disclosure. For example, although the description here is based on a case in which the present disclosure is applied to the cutting device 90 used in the sheet manufacturing apparatus 10 illustrated in FIG. 1 and the cutting method using this cutting device 90, the configuration is not limited to this case. The present disclosure is applicable to any cutting device for cutting a web including accumulated fibers and a cutting method using such a cutting device.

For example, although the description here is based on a case in which the present disclosure is applied to the cutting device 90 in which the cutter 91a cuts the second web W without interrupting transportation of the second web W and a cutting method using this cutting device 90, the present disclosure is applicable to a cutting device in which a cutter 91a cuts a second web W with transportation of the second web W interrupted and a cutting method using such a cutting device.

In addition, the layout, the shapes, and the like of the units in the cutting device 90 may be changed as appropriate, or a configuration not including some of the units may be possible. For example, a cutting device 90 having a configuration not including one of the upstream transportation mechanism 93 and the downstream transportation mechanism 94 is possible within a range in which the second web W can be appropriately cut. The present disclosure is applicable to a cutting device in which a cutter 91a cuts a second web W with transportation of the second web W interrupted and a cutting method using such a cutting device.

Although the description here is based on a case in which the cutter 91a cuts the second web W in the width direction, the present disclosure is not limited to this case. As a possible configuration, a cutter 91a may cut the second web W in a direction intersecting the transportation direction of the second web W. For example, the cutter 91a may cut the second web W at an angle oblique to the transportation direction. In addition, details of the operations, the order of the operations, and the like of the units including the cutter unit 91, the ball screw mechanism 92, and the web holding mechanism 110 may be changed as appropriate. The controller 95 is not limited to one dedicated to the cutting device 90, and a controller for another device may also serve as the controller 95. The controller that controls the operations of the cutter 91a, the ball screw mechanism 92, and the like can be changed as appropriate.

### 6. Summary of Present Disclosure

The following shows a summary of the present disclosure as appendixes.

(Appendix 1) A cutting device configured to be disposed on a transportation path along which a web including at least accumulated fibers is transported and configured to cut the web, the cutting device including: a cutter configured to cut the web; and a movable needle configured to stick into the web to hold the web when the web is cut.

This configuration enables the web including an uncompressed soft fiber material to be cut with the positional deviation of the web restricted, which improves cutting accuracy.

(Appendix 2) The cutting device according to Appendix 1, in which the needle is located below the web and moves up when the web is cut.

Since the needle is not disposed over the web in this configuration, it is easy to make a sufficient space over the web.

(Appendix 3) The cutting device according to Appendix 1, in which the needle is located above the web and moves down when the web is cut.

In this configuration, since the lower side of the web is supported by the transportation surface, and the needle sticks into the web from above, it is easy to sufficiently stick the needle into the web. In addition, since the needle is not disposed under the web, it is easy to make a sufficient space under the web.

(Appendix 4) The cutting device according to any one of Appendixes 1 to 3, in which a slit is located at a position facing the cutter with the web interposed therebetween, and the needle is located at at least one of an upstream position and a downstream position relative to the slit in a transportation direction of the web.

This configuration makes it easy to restrict the positional deviation of the web by using the needle while the slit prevents the cutter from coming into contact with the transportation surface. In addition, since the positional deviation of the web is restricted at a position away from the slit, it is easy to dispose the needle.

(Appendix 5) The cutting device according to Appendix 4, in which the needle is located at both the upstream position and the downstream position relative to the slit in the transportation direction of the web.

This configuration makes it possible to restrict the positional deviation of the web at an upstream position and a downstream position with respect to the cut portion of the web. This is advantageous to improving cutting accuracy.

(Appendix 6) The cutting device according to Appendix 4 or 5, further including a movable cover member configured to cover the slit when cutting is not performed.

With this configuration, the cover member prevents the web from being caught at the slit, smoothing the transportation of the web.

(Appendix 7) The cutting device according to any one of Appendixes 1 to 6, further including a ball screw mechanism configured to move the cutter and the needle in a transportation direction of the web when the web is being transported.

This configuration improves cutting accuracy when the cutter cuts the web without interrupting transportation of the web.

(Appendix 8) A cutting method using a cutting device disposed on a transportation path along which a web including at least accumulated fibers is transported, the cutting device including a cutter configured to cut the web and a movable needle configured to stick into the web, the cutting method including sticking the needle into the web to hold the web when the web is cut.

This cutting method enables the web including an uncompressed soft fiber material to be cut with the positional deviation of the web restricted, which improves cutting accuracy.

What is claimed is:

1. A cutting device configured to be disposed on a transportation path along which a web including at least accumulated fibers is transported and configured to cut the web, the cutting device comprising:
a cutter configured to cut the web; and
a movable needle configured to stick into the web to hold the web when the web is cut.

2. The cutting device according to claim 1, wherein
the needle is located below the web and moves up when the web is cut.

3. The cutting device according to claim 1, wherein
the needle is located above the web and moves down when the web is cut.

4. The cutting device according to claim 1, wherein
a slit is located at a position facing the cutter with the web interposed therebetween, and
the needle is located at at least one of an upstream position and a downstream position relative to the slit in a transportation direction of the web.

5. The cutting device according to claim 4, wherein
the needle is located at both the upstream position and the downstream position relative to the slit in the transportation direction of the web.

6. The cutting device according to claim 4, further comprising
a movable cover member configured to cover the slit when cutting is not performed.

7. The cutting device according to claim 1, further comprising
a ball screw mechanism configured to move the cutter and the needle in a transportation direction of the web when the web is being transported.

8. A cutting method using a cutting device disposed on a transportation path along which a web including at least accumulated fibers is transported, the cutting device including a cutter configured to cut the web and a movable needle configured to stick into the web, the cutting method comprising
sticking the needle into the web to hold the web when the web is cut.
